(19) United States
(12) Patent Application Publication
(10) Pub. No.: US 2009/0022575 A1
(43) Pub. Date: Jan. 22, 2009

(54) Article storing apparatus

(75) Inventor: Kimihiro Tsuge, Mie (JP)

Correspondence Address: DRINKER BIDDLE & REATH (DC), 1500 K STREET, N.W., SUITE 1100, WASHINGTON, DC, 20005-1209, US

(73) Assignee: ASYST SHINKO. INC.

(21) Appl. No.: 11/826,986

(22) Filed: Jul. 19, 2007

(51) Int. Cl. B65G 69/00

(52) U.S. Cl. 414/679

(57) ABSTRACT

An article storing apparatus is adapted to store an article transported by a carriage traveling along a traveling rail provided on a ceiling while being suspended. A storage space is provided above the ceiling. A rack is disposed in the storage space and adapted to store the article. A loader/unloader is operable to load the article from the carriage to the rack, and to unload the article from the rack to the carriage. A hoist transporter is movable in a vertical direction through the ceiling to transport the article between an inside and an outside of the storage space, and operable to deliver the article to the carriage and receive the article from the carriage. A storage transporter is disposed in the storage space and movable between the hoist transporter and the rack, and operable to deliver the article to the rack and receive the article from the rack.

### BACKGROUND

The present invention relates to an article storing apparatus for storing an article transported by a carriage suspended on a ceiling.

Japanese Patent Publication No. 2001-159304A, discloses that automated storages (article storing apparatuses) for storing substrates during manufacture are provided to correspond to manufacturing processes in a liquid crystal display manufacturing plant and that the substrates (articles) manufactured in the manufacturing processes are transported to a corresponding automated storage by the use of an automatic transporter (carriage) and then is transported to an automated storage corresponding to another manufacturing process by the use of a ceiling-guided transporter provided in the automated storage so as to transport the substrates between the automated storages, whereby the substrates are transported from the automated storage to another manufacturing process.

In the above publication, the automated storages are provided adjacent to the corresponding manufacturing processes, but when it is necessary to enhance capacities of the automated storages with an improvement in production capacity, the automated storage may not be disposed adjacent to the corresponding manufacturing processes in consideration of a spatial relationship so as to dispose the automated storages on the same floor as the corresponding manufacturing processes. When the automated storage is disposed away from the corresponding manufacturing process, it takes the automatic transporter longer time to transport the substrate between the automated storage and the corresponding process.

### SUMMARY

It is therefore one advantageous aspect of the invention to provide an article storing apparatus capable of reducing a transport time using a carriage and enhancing an article storing capacity.

According to one aspect of the invention, there is provided an article storing apparatus, adapted to store an article transported by a carriage traveling along a traveling rail provided on a ceiling while being suspended, the article storing apparatus comprising:

a storage space, provided above the ceiling;

a rack, disposed in the storage space and adapted to store the article; and

a loader/unloader, operable to load the article from the carriage to the rack, and to unload the article from the rack to the carriage, the loader/unloader comprising:

a hoist transporter, movable in a vertical direction through the ceiling to transport the article between an inside and an outside of the storage space, and operable to deliver the article to the carriage and receive the article from the carriage; and

a storage transporter, disposed in the storage space and movable between the hoist transporter and the rack, and operable to deliver the article to the rack and receive the article from the rack.

With this configuration, it is possible to enhance the article storing capacity and to effectively utilize spaces in a plant, a facility, or the like by using a space under the roof as a storage space for storing articles. Since an hoist transporter can be provided at an arbitrary position of the ceiling, a time for transporting the articles using the carriage is reduced by disposing the hoist transporter adjacent to a transport destination and a transport source of the article.

A plurality of racks may be extending in one direction and arranged parallel to each other. The storage transporter may comprise: a first traveling rail, disposed between adjacent ones of the racks and extending in a direction that the racks extend; and a first storage carriage, traveling along the first traveling rail and operable to deliver the article to the racks and receive the article from the racks.

With this configuration, when a plurality of racks are disposed parallel to each other in one direction, the first storage carriage delivers and receives the article to and from the rack by traveling along the first traveling rail disposed between the adjacent racks, whereby it is possible to deliver and receive the article to and from the rack.

The storage transporter may further comprise: a second traveling rail, disposed so as to surround the racks; and a second storage carriage, traveling along the second traveling rail and operable to deliver the article to the hoist transporter and the first storage carriage, and receive the article from the hoist transporter and the first storage carriage.

With this configuration, since the article can be delivered and received between the loader/unloader and the first storage carriage corresponding to an arbitrary rack by the use of the second storage carriage traveling along the second traveling rail surrounding the racks, it is possible to further enhance the article storing capacity of the storage space by increasing the numbers of the racks and the first storage carriages corresponding to the racks. Since the first storage carriage and the second storage carriage are movable independently of each other, it is possible to effectively take the article in and out of the rack.

The storage transporter may further comprise: a first conveyer, disposed so as to surround the racks and operable to transport the article; and a second conveyer, branched from the first conveyer and extending to the vicinity of the storing position. The hoist transporter may be operable to deliver the article to the second conveyer and receive the article from the second conveyer. The first storage carriage may be operable to deliver the article to the first conveyer and receive the article from the first conveyer.

With this configuration, since the article can be delivered and received between the loader/unloader and the first storage carriage corresponding to the arbitrary rack by the use of the first conveyor surrounding the racks, it is possible to further enhance the article storing capacity of the storage space by increasing the numbers of the racks and the first storage carriages corresponding to the racks. Since the first storage carriage and the first and second conveyors are movable independently of each other, it is possible to efficiently take the article in and out of the rack. Since the article can be immediately delivered and received between the loader/unloader and the second conveyor, and between the first conveyor and the second conveyor by providing the first and second conveyors, it is possible to further efficiently take the article in and out of the rack.

### BRIEF DESCRIPTION OF THE DRAWINGS

FIG. 1 is a schematic diagram showing a part of a transport system according to one embodiment of the invention which is other than a roof-space;

FIG. 2 is a perspective view showing one of lifter units in the transport system of FIG. 1 and a part in the roof-space corresponding to the one lifter unit;

FIG. 3 is a plan view of the part in the roof-space of FIG. 2.

FIG. 4 is a plan view showing a first modified example corresponding to FIG. 3.

FIG. 5 is a plan view showing a second modified example corresponding to FIG. 3.

### DETAILED DESCRIPTION OF THE EXEMPLARY EMBODIMENTS

Exemplary embodiments of the invention will be described below in detail with reference to the accompanying drawings.

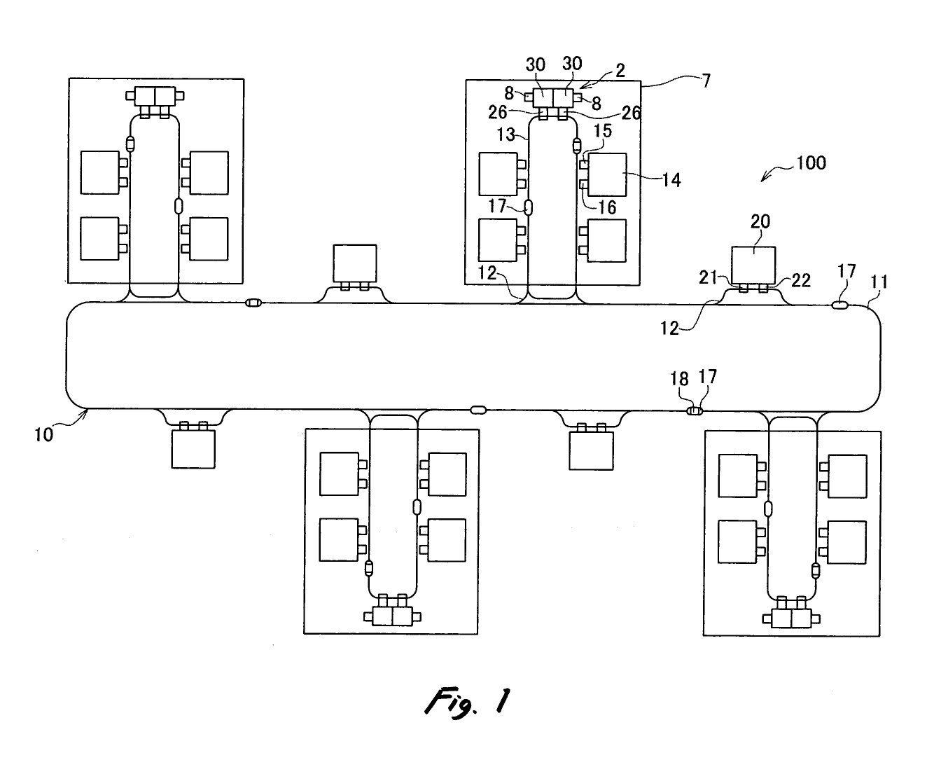

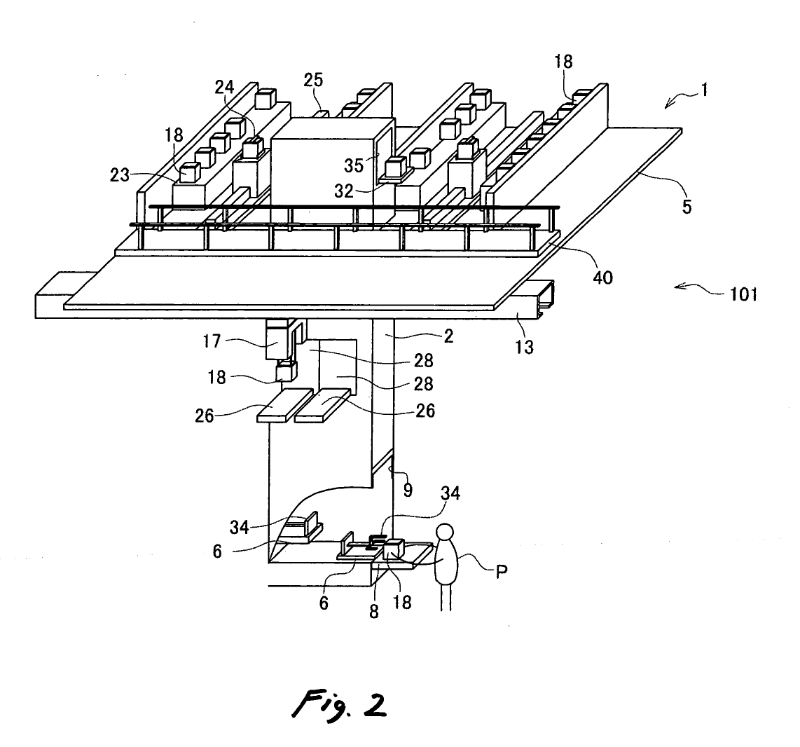

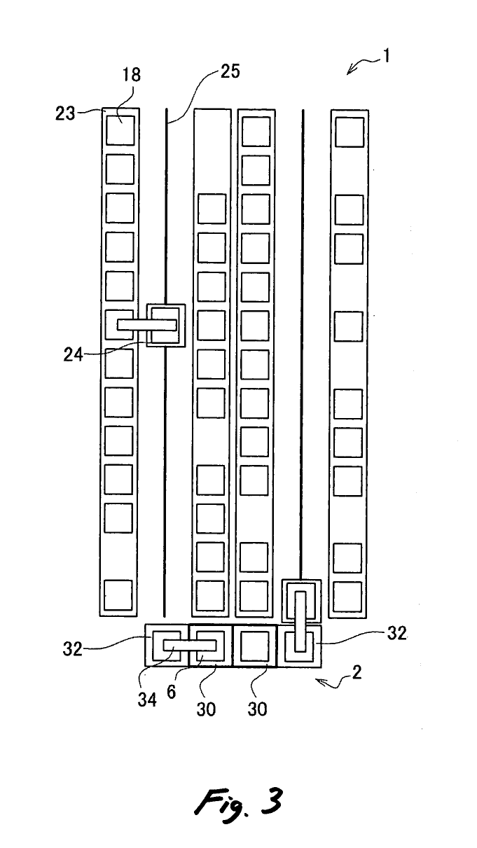

FIG. 1 is a plan view of a part other than a space under the roof in a transport system 10 according to one embodiment of the invention. FIG. 2 is a perspective view of one lifter unit 2 of FIG. 1 and a part under the roof corresponding to the lifter unit 2. FIG. 3 is a plan view of the part under the roof of FIG. 2. The transport system 10 which is provided in a clean room in a semiconductor manufacturing plant includes four bays 7, four stockers 20, a transport rail 10, OHT (Overheat Hoist Transport) carriages 17, and a storing apparatus (article storing apparatus) 101 as shown in FIGS. 1 to 3.

Two out of the four bays 7 are arranged in an upper side of FIG. 1 to form two rows, and the other two are arranged in an lower side of FIG. 1 to form two rows. Four semiconductor manufacturing equipments 14 are provided in each bay 7 and semiconductor manufacturing processes are performed by the semiconductor manufacturing equipments 14. A loading port 15 for loading carriers (articles) 18 for transporting a product under a manufacturing operation and an unloading port 16 for unloading the carriers 18 are provided in each of semiconductor manufacturing equipments 14. The four stockers 20 are disposed adjacent to the four bays 7, respectively. The carriers 18 are stored inside each of the four stockers 20. A loading port 21 for loading the carriers 18 and an unloading port 22 for unloading the carriers 18 are provided in each of the stockers 20.

The transport rail 10 is a rail suspended on the ceiling. The OHT carriages 17 suspended on the transport rail 10 travels along the transport rail 10 (the OHT carriages 17 are supported to be movable along the transport rail 10). The OHT carriages 17 travel along the transport rail 10 with the carriers 18 mounted thereon, and thus the carriers 18 are transported to the semiconductor manufacturing equipments 14, the stockers 15 and the lifter units 2 (described later) of a storing apparatus 101.

The transport rail 10 includes interprocess rails 11, branch rails 12 and intraprocess rails 13. The interprocess rails 11 are circular rails extending in the vertical direction of FIG. 1. The OHT carriages 17 travels along the interprocess rails 11, and thus the carrier 18 is transported between the bays 7 and between the bays 7 and the stockers 20.

The branch rails 12 are rails branched from the interprocess rails 11 in correspondence with the four bays 7 and the four stockers 20. The OHT carriages 17 move between the interprocess rails 11 and the intraprocess rails 13 through the branch rails 12. The OHT carriages 17 move to upsides of the loading ports 21 of the stockers 20 along the branch rails 12 so as to transfer the carriers 18 to the loading ports 21 and move to upsides of the unloading ports 22 so as to transfer the carriers 18 mounted on the unloading ports 22 to the OHT carriages 17.

The intraprocess rails 13 are rails arranged at upsides of the bays 7. When the carriers 18 are loaded to the semiconductor manufacturing equipments 14, the OHT carriages 18 travel along the intraprocess rails 13 and move to the upsides of the unloading ports 15 of the semiconductor manufacturing equipments 14 so as to mount the carriers 18 on the loading ports 15 and when carriers 18 are unloaded from the semiconductor manufacturing equipments 14, the OHT carriages 17 travel along the intraprocess rails 13 and move to the upsides of the unloading ports 16 of the semiconductor manufacturing equipments 14 so as to transfer the carriers 18 mounted on the unloading ports 16 to the OHT carriages 17.

The storing apparatus 101 is an apparatus for storing the carriers 18, which is provided independently from the stocker 20. The storing apparatus 101 includes a storage space 1 provided under the roof of the clean room, four racks 23 provided in the storage space 1, two rails (first traveling rails) 25, two transfer robots (first storage carriages) 24, a work platform 40 and the lifter units 2.

The storage space 1 is a space using an upper face of a ceiling 5 as a bottom face thereof. The four racks 23 are substantially rectangular-shaped racks for storing the carriers 18, which are arranged in the storage space 1 in parallel with each other in a lateral direction of FIG. 3. Each of the two rails 25 extends parallel to the racks 23 between the first rack 23 and second rack 23 from the left side of FIG. 3, and between the third rack 23 and the fourth rack 23 from the left side of FIG. 3. The two transfer robots 24 travel between the racks 23 and storing ports 32 (lifters 30) along the two rails 25 so as to mount the carriers 18 on the racks 23 or transfer the carriers 18 mounted on the racks 23 to the transfer robots 24 (the carriers 18 are delivered to and received from the racks 23). The transfer robots 24 move to a portion adjacent to the storing ports 32 (described later) along the rails 25 so as to transfer the carriers 18 to the storing ports 32 or transfer the carriers 18 mounted on the storing ports 32 to the transfer robots 24. The work platform 40 is provided in front of the lifter units 2 of FIG. 2 and is a platform which a worker uses for a maintenance check.

As described above, the storage space 1 for storing the carriers 18 under the roof of the clean room is provided, and thus it is possible to enhance a capacity for storing the carriers 18 and to efficiently use a space of the clean room. In the storage space 1, the racks 23 are arranged parallel to each other and the transfer robots 24 are moved along the rails 25 disposed between the adjacent racks 23, whereby the carriers 18 can be efficiently delivered and received between the racks 23 and the transfer robots 24. In addition, the rails 25 and the transfer robots 24 serve as storage transporters.

The lifter units 2 are cylindrical bodies having a substantially rectangular parallelepiped outer shape and extend in a vertical direction through the upside of each bay 7 of the ceiling 5. Here, since the lifter unit 2 can be provided at an arbitrary position of the ceiling 5, the lifter units 2 are provided close to the bays 7 as shown in FIGS. 1 and 2, and thus it takes the OHT carriages 17 shorter time to transport the carriers 18 between the semiconductor manufacturing equipments 14 and the lifter units 2. The lifter unit 2 includes two lifter (hoist transporters) 30. Each of the lifters 30 includes hoists 6, transfer devices 34, loading/unloading ports 26, a storing port 32 and a ground port 8. The hoists 6 are mounted with the carriers 18 and elevate in the vertical direction so as to transport the carriers 18 to the loading/unloading ports 26 and the storing port 32 inside the lifters 30 (the lifter unit 2) (the hoists 6 elevate through the ceiling 5 so as to transport the carriers 18 to an inside and an outside of the storage space 1). The transfer devices 34 are disposed on upper faces of the hoist 6 and the carriers 18 are mounted on the hoists 6. The carriers 18 mounted on the hoists 6 are transferred to the loading/unloading ports 26 and the storing port 32.

The loading/unloading ports 26 extend substantially in the horizontal direction outwardly from loading/unloading holes 28 formed in the lifter 2 below the OHT carriage 17 traveling on the intraprocess rail 13. The carriers 18 are transferred from the OHT carriage 17 to the loading/unloading ports 26. The carriers 18 transferred to the loading/unloading ports 26 are further transferred to the hoists 6. Alternatively, the carriers 18 are transferred from the hoists 6 to the loading/unloading ports 26. The carriers 18 transferred to the loading/unloading ports 26 are further transferred to the OHT carriage 17. That is, the carriers 18 are delivered and received between the OHT carriage 17 and the hoists 6 (the lifters 30) through the loading/unloading ports 26.

The storing port 32 extends substantially in the horizontal direction outwardly from a storing hole 35 formed adjacent to the lifter unit 2. The carriers 18 are transferred from the hoists 6 to the storing port 32. The carriers 18 transferred to the storing port 32 are transferred to the transfer robots 24. Alternatively, the carriers 18 are transferred from the transfer robots 24 to the storing port 32. The carriers 18 transferred to the storing port 18 are further transferred to the hoists 6. That is, the carriers 18 are delivered and received between the hoists 6 and the transfer robots 24 through the storing port 32.

The ground port 8 extends substantially in the horizontal direction outwardly from the ground loading/unloading hole 9 formed adjacent to a lower end of the lifter unit 2. The carriers 18 are transferred to the ground port 8 by a worker P. The carriers 18 transferred to the ground port 8 are further transferred to the hoists 6. Alternatively, the carriers 18 are transferred to the ground port 8 by the hoists 6. The carriers 18 transferred to the ground port 8 are taken out by the worker P. That is, the carriers 18 are delivered and received between the worker P and the hoists 6 through the ground port 8.

The loader/unloader of the invention includes the above-mentioned rails 25 and transfer robots 24 serving as the storage transporter of the invention in addition to the lifter units 2. The loader/unloader loads the carriers 18 to the racks 23 from the OHT carriages 17 and unloads the carriers 18 from the racks 23 to the OHT carriages 17.

Here, a method of storing the carriers 18 in the racks 23 and a method of taking out the carriers 18 stored in the racks 23 are described.

In order to store the carriers 18 in the racks 23, the OHT carriage 17 moves to the upsides of the unloading ports 16 of the semiconductor manufacturing equipments 14, which are mounted with the carriers 18 stored in the racks 23, and thus the carriers 18 are transferred from the unloading ports 16 to the OHT carriages 17. The OHT carriages 17 move to the upsides of the loading/unloading ports 26 of the lifters 30 (the lifter unit 2) provided in the same bay 7, and thus the carriers 18 are transferred to the loading/unloading ports 26. At this time, since the lifters 30 extend in the vertical direction through the upside of each bay 7 of the ceiling 5 and are disposed adjacent to each bay 7, it takes shorter time to move the OHT carriages 17 from the unloading ports 16 to the loading/unloading ports 26.

Next, the hoists 6 move to the same level as the loading/unloading holes 28 and the carriers 18 transferred to the loading/unloading ports 26 are transferred to the hoists 6 by the transfer devices 34. The hoists 6 move to the same level as the storing hole 35 and the carriers 18 are transferred from the hoists 6 to the storing port 32 by the transfer devices 34.

Next, the transfer robots 24 move to a position adjacent to the storing port 32 along the rails 25 and the carriers 18 transferred to the storing port 32 are transferred to the transfer robots 24. The transfer robots 24 move to positions opposed to portions of the racks 23 where the carriers 18 will be stored along the rails 25 and the carriers 18 are transferred from the transfer robots 24 to the racks 23, whereby the carriers 18 are stored in the racks 23.

Meanwhile, in order to take out the carriers 18 stored in the racks 23, the transfer robots 24 move along the rails 25 to the positions opposed to the portions of the racks 23 where the carriers 18 to be taken out are stored, and the carriers 18 are transferred from the racks 23 to the transfer robots 24. Next, the transfer robots 24 move to the position adjacent to the storing port 32 along the rails 25 and the carriers 18 are transferred from the transfer robots 24 to the storing port 32.

Next, the hoists 6 move to the same level as the storing hole 35 and the carriers 18 are transferred from the storing port 32 to the hoists 6 by the transfer devices 34. The hoists 6 move to the same level as the loading/unloading holes 28 and the carriers 18 are transferred from the hoists 6 to the loading/unloading ports 26 by the transfer devices 34.

Next, the OHT carriage 17 move to the upsides of the loading/unloading ports 26 and the carriers 18 are transferred from the loading/unloading ports 26 to the OHT carriage 17. The OHT carriages 17 move to the upsides of the loading ports 15 of the semiconductor manufacturing equipments 14 of a transport destination and the carriers 18 are transferred from the OHT carriages 17 to the loading ports 15. At this time, since the lifters 30 extend in the vertical direction through the upside of each bay 7 of the ceiling 5 and are disposed adjacent to each bay 7, it takes shorter time to move the OHT carriages 17 from the loading/unloading ports 26 to the loading ports 15.

A method of storing the carriers 18 into the storing apparatus 101 from the ground port 8 and a method of taking the carriers 18 stored in the storing apparatus 101 out of the ground port 8 are the same as the above-mentioned methods, and thus descriptions thereof will be hereinafter omitted.

According to the embodiment described above, it is possible to effectively enhance the capacity for storing the carriers 18 and to effectively utilize the space for the clean room by using the space under the roof of the clean room as the storage space 1 for storing the carriers 18. Since the lifter unit 2 can be provided at an arbitrary position of the ceiling 5, a time when it takes the OHT carriage 17 to transport the carriers 17 is reduced by disposing the lifter unit 2 at a position adjacent to the bay 7 having the semiconductor manufacturing equipments 14, which is the transport destination and the transport source.

In the storage space 1, the racks 23 are arranged parallel to each other and the transfer robots 24 extend between the adjacent racks 23 along the rails 25 extending in extending directions of the racks 23, whereby the carriers 18 can be efficiently delivered and received between the racks 23 and the transfer robots 24.

Next, modified examples in which the embodiment is modified in a variety of forms will be described. However, constituent elements having the same configuration as the embodiment are denoted by the same reference numerals and descriptions thereof are omitted.

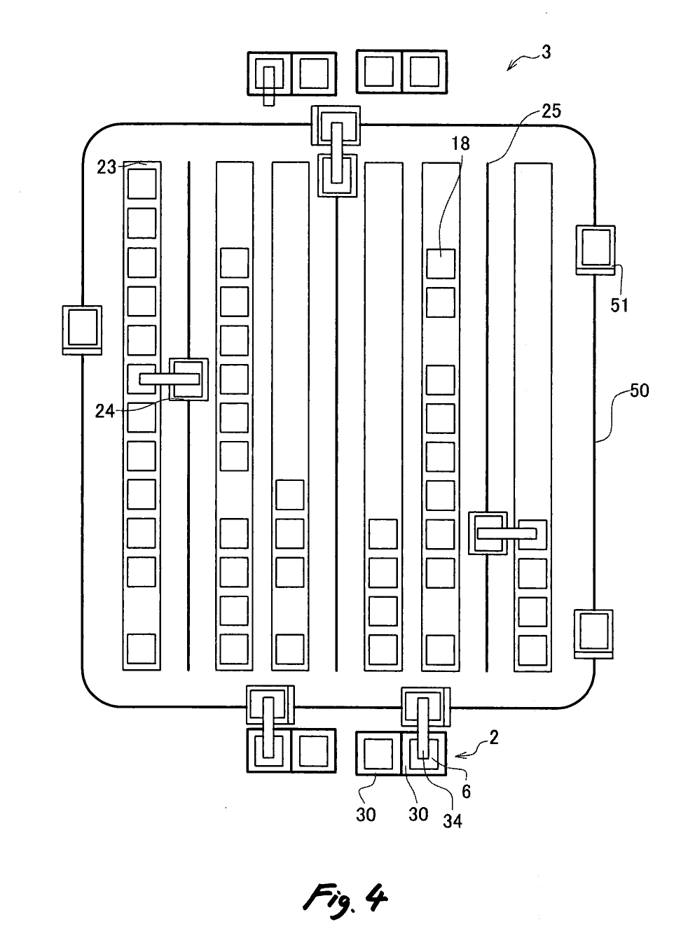

In one modified example, as shown in FIG. 4, in the storage space 3, six racks 23 are arranged parallel to each other in a horizontal direction of FIG. 4, the rails 25 are disposed between the first and second racks 23 from the left side, between the third and fourth racks 23 from the left side and between fifth and sixth racks 23 from the left side, and the transfer robots 24 travel along the rails 25. A rail (a second traveling path) 50 surrounds the six racks 23 and the three rails 25 and an OHS (Over Head Shuttle) carriages (second storage carriages) 51 travel along the rail 50 (first modified example). In this case, when the carriers 18 are stored in the storage space 3, the hoists 6 mounted with the carriers 18 move to the same level as the storing hole 35 (see FIG. 2) as described above. The carriers 18 are transferred from the hoists 6 to the OHS carriages 51 moving to the position adjacent to the hoists 6 by the transfer devices 34 and the OHS carriages 51 moves adjacent to one end of the rails 25 on which the transfer robot 24 corresponding to the rack 23 in which the carriers 18 are stored travels, whereby the carriers 18 are transferred from the OHS carriage 51 to the transfer robot 24 at the position adjacent to one end of the rail 25.

Meanwhile, when the carriers 18 stored in the storage space 3 are taken out, the OHS carriage 51 moves adjacent to the one end of the rails 25 on which the transfer robot 24 corresponding to the rack 23 storing the carriers 18 to be taken out travels and the carriers 18 are transferred from the transfer robot 24 to the OHS carriage 51. The OHS carriage 51 moves to the position adjacent to the lifter unit 2 along the rail 50 and the carriers 18 are transferred from the OHS carriage 51 to the hoists 6 by the transfer devices 34.

In this case, since the carriers 18 are delivered and received between the hoists 6 and the transfer robots 24 by the use of the OHS carriages 51 traveling along the rail 50 which surrounding the plurality of racks 23, the lifter units 2 and the rails 25 may be disposed away from each other and it is possible to enhance the capacity of the storage space 3 for storing the carriers 18 by increasing the numbers of the racks 23, the rails 25 and the transfer robots 24.

Since the transfer robots 24 and the OHS carriages 51 are movable independently of each other, the carriers 18 can be delivered and received between the OHS carriages 51 and the hoists 6 while the transfer robots 24 deliver and receive the carriers 18 to and from the racks 23, and thus it is possible to efficiently store the carriers 18 into the storage space 3 and take the carriers 18 out of the storage space 3.

In the first modified example, the number of the racks 23 is set to six and the numbers of the rails 25 and the transfer robots 24 are set to three, but the numbers of the racks 23, the rails 25 and the transfer robots 24 may be properly increased to suit the size of the storage space 3. In the first modified example, the rails 25, the transfer robots 24, the rail 50 and the OHS carriages 51 serve as the storage transporter of the invention.

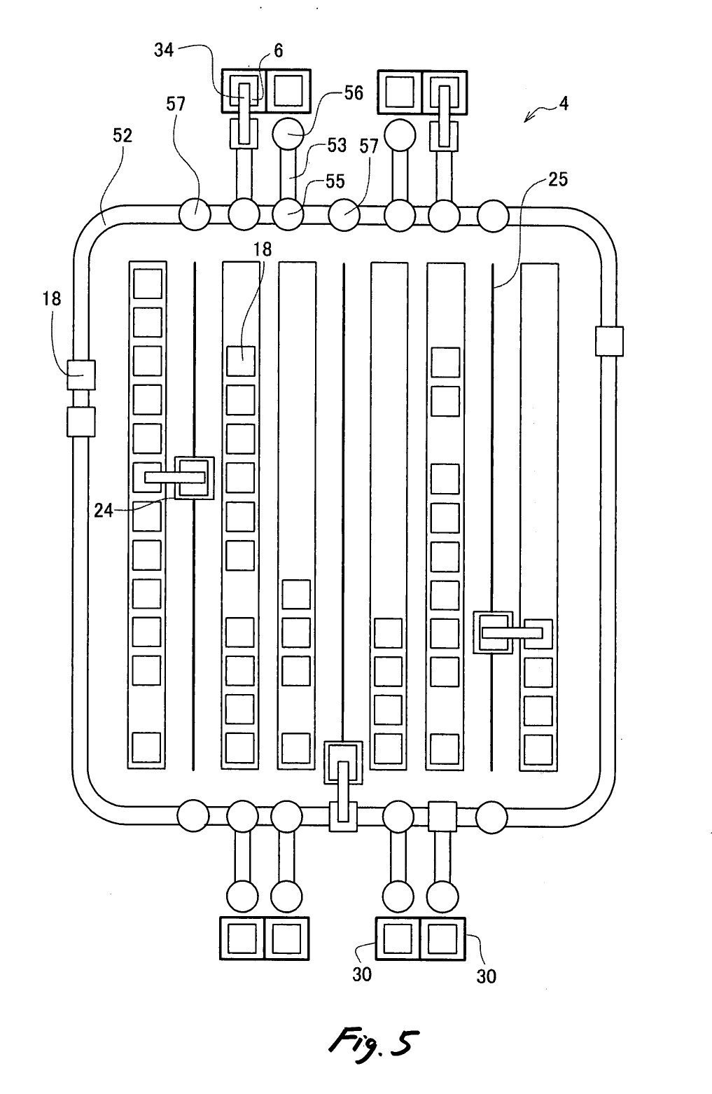

In another modified example, as shown in FIG. 5, in a storage space 4 similarly as the first modified example, the six racks 23 are arranged parallel to each other in the lateral direction of FIG. 5, the rails 25 are disposed between the first and second racks 23 from the left side, between the third and fourth racks 23 from the left side and between fifth and sixth racks 23 from the left side, and the transfer robots 24 travel along the rails 25. A conveyor (first conveyor) 52 surrounds the six racks 23 and the three rails 25 and a conveyor (second conveyor) 53 branched from the conveyor 52 extends to a position adjacent to the lifter units 2. Turntables 55, 56 and 57 are provided at a branch point between the conveyor 52 and the conveyor 53, at a portion adjacent to the lifter unit 2 of the conveyor 53, and at portions adjacent to both ends of the rail 25 of the conveyor 52, respectively (second modified example).

In this case, when the carriers 18 are stored in the storage space 4, the hoists 6 mounted with the carriers 18 move to the same level as the storing hole 35 (see FIG. 2) as described above. The carriers 18 are transferred from the hoists 6 to the turntable 56 by the transfer device 34. The carriers 18 are transported to the turntable 55 provided at the branch point between the conveyor 52 and the conveyor 53 along the conveyor 53. The carriers 18 are transported to an upside of the turntable 57 disposed adjacent to the one end of the rail 25 corresponding to the rack 23 in which the carriers 18 are stored along the conveyor 52 and fixed to the upside by the turntable 57. The carriers 18 fixed and transported to the turntable 57 are transferred to the transfer robots 24. Meanwhile, when the carriers 18 stored in the storage space 4 are taken out, the transport robot 24 corresponding to the rack 23 storing the carriers 18 to be taken out mounts the carriers 18 on the turntable 55 adjacent to the one end of the rails 25. The carriers 18 are transported to the turntable 55 disposed at the branch point between the conveyor 52 and the conveyor 53 extending between the lifter unit 2 corresponding to the bay 7 (see FIG. 1) having the semiconductor manufacturing equipment 14 (see FIG. 1) of the transport destination and the conveyor 52, along the conveyor 52, and then, the carriers 18 are transported to the conveyor 52 by the turntable 55. The carriers 18 are transported to the turntable 56 adjacent to the lifter units 2 by the conveyor 52 and fixed to the position by the turntable 56. The carriers 18 fixed to the turntable 56 are transferred to the hoists 6 by the transfer devices 34.

In this case, since the carriers 18 are delivered and received between the hoists 6 and the transfer robots 24 through the conveyor 52 surrounding the plurality of racks 23 and the conveyor 53 branched from the conveyor 52, the lifter units 2 and the rails 25 may be disposed away from each other and it is possible to enhance the capacity of the storage space 4 for storing the carriers 18 by increasing the numbers of the racks 23, the rails 25 and the transfer robots 24.

Since the transfer robots 24, and the conveyors 52 and 53 operate independently of each other, the carriers 18 can be delivered and received between the hoists 6 and the conveyor 53 while the transfer robots 24 deliver and receive the carriers 18 to and from the racks 23, and thus it is possible to efficiently store the carriers 18 in the storage space 4 and take the carriers 18 out of the storage space 4. The carriers 18 are transported from the hoists 6 to the transfer robots 24 by the conveyors 52 and 53. Therefore, when the carriers 18 are delivered to and received from the hoists 6, the carriers 18 are immediately delivered and received between the hoists 6 and the conveyor 53 without waiting for the OHS carriage 51 (see FIG. 4) to move adjacent to the hoists 6 as described in first modified example, and the carriers 18 can be transported to the conveyor 52, whereby the carriers 18 can be, it is possible to more efficiently store the carriers 18 in the storage space 4 and take the carriers 18 out of the storage space 4.

Even in the second modified example, similarly to the first modified example, the numbers of the racks 23, the rails 25 and the transfer robots 24 may be properly increased to suit the size of the storage space 4. In second modified example, the rails 25, the transfer robots 24, the conveyors 52 and 53, and the turntables 55 to 57 serve as the storage transporter of the invention.

In the embodiments, an example that the OHT carriage 17 is used as the carriage has been described, but carriages such as an OHS carriage other than the OHT carriage 17 may be used as the carriage.

In the embodiments, the two lifters 30 constituting the lifter unit 2 are used to store the carriers 18 in the storage space 1 and to take the carriers 18 out of the storage space 1, but one of the two lifters 30 is used only to store the carriers 18 in the storage space 1 and the other is used only to take the carriers 18 out of the storage space 1. An air shower may be provided adjacent to the storing hole 32 of the lifter 30 used to take the carriers 18 out of the storage space 1. In this case, even though a slight dust exists in the storage space 1 and the slight dust is attached to the carriers 18, the slight dust is removed by the air shower, and thus it is possible to prevent the dust from entering the clean room.

When the storage space 1 is in communication with outside air, a filter for removing dusts belonging to the outside air are removed from the storage space 1 and preventing the dusts from entering the storage space 1 may be provided.

In the embodiments, the upper face of the ceiling 5 has a flat structure, but it may have a grating structure.

In the above-mentioned description, the printer according to the embodiment has been described, but the invention is not limited to all the above-mentioned embodiments. Various changes and modifications may be made within the scope without departing from the claims.

The disclosure of Japanese Patent Application No. 2006-190149 filed Jul. 11, 2006 including specification, drawings and claims is incorporated herein by reference in its entirety.

1. An article storing apparatus, adapted to store an article transported by a carriage traveling along a traveling rail provided on a ceiling the article storing apparatus comprising:
a storage space, provided above the ceiling;
a at least one rack, disposed in the storage space and adapted to store the article; and
a loader/unloader, operable to load the article from the carriage to the rack, and to unload the article from the rack to the carriage, the loader/unloader comprising:
a hoist transporter, movable in a vertical direction through the ceiling to transport the article between an inside and an outside of the storage space, and operable to deliver the article to the carriage and receive the article from the carriage; and
a storage transporter, disposed in the storage space and movable between the hoist transporter and the rack, and operable to deliver the article to the rack and receive the article from the rack.

2. The article storing apparatus as set forth in claim 1, wherein:
the at least one rack includes a plurality of racks extending in a first direction and arranged parallel to each other;
the storage transporter comprises:
a first traveling rail, disposed between adjacent ones of the racks and extending in the first direction ; and
a first storage carriage, traveling along the first traveling rail and operable to deliver the article to the racks and receive the article from the racks.

3. The article storing apparatus as set forth in claim 2, wherein:
the storage transporter further comprises:
a second traveling rail, extending so as to surround the racks; and
a second storage carriage, traveling along the second traveling rail and operable to deliver the article to the hoist transporter and the first storage carriage, and receive the article from the hoist transporter and the first storage carriage.

4. The article storing apparatus as set forth in claim 2, wherein:
the storage transporter further comprises:
a first conveyer, extending so as to surround the racks and operable to transport the article; and
a second conveyer, branched from the first conveyer and extending to a position in the vicinity of the storing hoist transporter; and
the hoist transporter is operable to deliver the article to the second conveyer and receive the article from the second conveyer; and
the first storage carriage is operable to deliver the article to the first conveyer and receive the article from the first conveyer.
